(19) United States
(12) Patent Application Publication
(10) Pub. No.: US 2026/0038425 A1
(43) Pub. Date: Feb. 5, 2026

(54) PIXEL AND ELECTRONIC APPARATUS INCLUDING THE SAME

(71) Applicant: Samsung Display Co., Ltd., Yongin-si (KR)

(72) Inventor: JUNHYUN PARK, Yongin-si (KR)

(21) Appl. No.: 19/213,662

(22) Filed: May 20, 2025

(30) Foreign Application Priority Data
Jul. 30, 2024 (KR) 10-2024-0100932
Mar. 11, 2025 (KR) 10-2025-0031026

(51) Int. Cl. G09G 3/32

(52) U.S. Cl. CPC G09G 3/32; G09G 2300/043; G09G 2300/0819; G09G 2310/08; G09G 2330/021

(57) ABSTRACT

A pixel includes: a first transistor including a gate connected to a first node, a first terminal to receive a first power voltage, a second terminal connected to a second node, and a body connected to a third node; a second transistor to transmit a data signal to the third node in response to a write gate signal; a third transistor to connect the first node to the second node in response to a compensation gate signal; a first capacitor connected between the third node and a first voltage line to transmit a first voltage; a second capacitor connected between the first node and a second voltage line to transmit a second voltage; and a light-emitting element including a first terminal connected to the second node, and a second terminal to receive a second power voltage.

### CROSS-REFERENCE TO RELATED APPLICATION(S)

The present application claims priority to and the benefit of Korean Patent Application No. 10-2024-0100932, filed on Jul. 30, 2024, and Korean Patent Application No. 10-2025-0031026, filed on Mar. 11, 2025, in the Korean Intellectual Property Office, the entire disclosures of all which are incorporated by reference herein.

### BACKGROUND

### 1. Field

Aspects of embodiments of the present disclosure relate to a pixel including a plurality of transistors and a plurality of capacitors, a display device including the pixel, and an electronic apparatus including the display device.

### 2. Description of the Related Art

A display device may include a plurality of pixels that display a plurality of colors, respectively. Each of the pixels may be a minimum unit that displays one color, and the display device may display an image in which the colors displayed by the pixels are combined with each other.

Recently, a demand for a display device having a high resolution has been increasing. In order to increase the resolution of the display device, the area of the pixel may be reduced.

The above information disclosed in this Background section is for enhancement of understanding of the background of the present disclosure, and therefore, it may contain information that does not constitute prior art.

### SUMMARY

One or more embodiments of the present disclosure may be directed to a pixel having a reduced area.

One or more embodiments of the present disclosure may be directed to a display device having a high resolution, and an electronic apparatus including the display device.

According to one or more embodiments of the present disclosure, a pixel includes: a first transistor including a gate connected to a first node, a first terminal configured to receive a first power voltage, a second terminal connected to a second node, and a body connected to a third node; a second transistor configured to transmit a data signal to the third node in response to a write gate signal; a third transistor configured to connect the first node to the second node in response to a compensation gate signal; a first capacitor connected between the third node and a first voltage line configured to transmit a first voltage; a second capacitor connected between the first node and a second voltage line configured to transmit a second voltage; and a light-emitting element including a first terminal connected to the second node, and a second terminal configured to receive a second power voltage.

In an embodiment, in a third node initialization period of an initialization period, each of the first power voltage, the first voltage, and the second voltage may have a high level, the write gate signal may have an activation level, and the data signal may have a sustain voltage.

In an embodiment, in a second node initialization period of the initialization period after the third node initialization period, each of the first power voltage, the first voltage, and the second voltage may have a low level.

In an embodiment, in a first node initialization period of the initialization period after the second node initialization period, the second voltage may transition from the low level to the high level, and the compensation gate signal may have an activation level.

In an embodiment, in a compensation period after the initialization period, the write gate signal may have the activation level, the compensation gate signal may have an activation level, and the data signal may have a reference voltage.

In an embodiment, in a writing period after the compensation period, the write gate signal may have the activation level, and the data signal may have a data voltage.

In an embodiment, in a bypass period after the writing period, each of the first power voltage, the first voltage, and the second voltage may have a low level.

In an embodiment, in an emission period after the bypass period, the first power voltage may have the high level, and the second power voltage may have a low level.

In an embodiment, the first transistor may be a p-type metal oxide semiconductor (PMOS) transistor, and each of the second transistor and the third transistor may be an n-type metal oxide semiconductor (NMOS) transistor.

In an embodiment, the first transistor may be a PMOS transistor, and at least one of the second transistor or the third transistor may be a PMOS transistor.

In an embodiment, the pixel may further include a fourth transistor configured to transmit an initialization voltage to the second node in response to an initialization gate signal.

According to one or more embodiments of the present disclosure, a pixel includes: a first transistor including a gate connected to a first node, a first terminal configured to receive a first power voltage, a second terminal connected to a second node, and a body connected to a third node; a second transistor configured to transmit a data signal to the first node in response to a write gate signal; a third transistor configured to connect the second node to the third node in response to a compensation gate signal; a first capacitor connected between the first node and a first voltage line configured to transmit a first voltage; a second capacitor connected between the third node and a second voltage line configured to transmit a second voltage; and a light-emitting element including a first terminal connected to the second node, and a second terminal configured to receive a second power voltage.

In an embodiment, in an initialization period, each of the first power voltage and the first voltage may have a low level, and the compensation gate signal may have an activation level.

In an embodiment, in a compensation period after the initialization period, the first power voltage may have a high level, the write gate signal may have an activation level, the compensation gate signal may have the activation level, and the data signal may have a reference voltage.

In an embodiment, in a writing period after the compensation period, the write gate signal may have the activation level, and the data signal may have a data voltage.

In an embodiment, in a bypass period after the writing period, each of the first power voltage and the first voltage may have the low level.

In an embodiment, in an emission period after the bypass period, the first power voltage may have the high level, and the second power voltage may have a low level.

In an embodiment, the pixel may further include a fourth transistor configured to transmit an initialization voltage to the second node in response to an initialization gate signal.

According to one or more embodiments of the present disclosure, an electronic apparatus includes: a processor configured to generate input image data; and a display device configured to display an image corresponding to the input image data, the display device including: a display panel including pixels; a gate driver configured to provide a write gate signal and a compensation gate signal to each of the pixels; a data driver configured to provide a data signal to each of the pixels; and a power management circuit configured to provide a first power voltage, a second power voltage, a first voltage, and a second voltage to each of the pixels. Each of the pixels includes: a first transistor including a gate connected to a first node, a first terminal configured to receive the first power voltage, a second terminal connected to a second node, and a body connected to a third node; a second transistor configured to transmit the data signal to the third node in response to the write gate signal; a third transistor configured to connect the first node to the second node in response to the compensation gate signal; a first capacitor connected between the third node and a first voltage line configured to transmit the first voltage; a second capacitor connected between the first node and a second voltage line configured to transmit the second voltage; and a light-emitting element including a first terminal connected to the second node, and a second terminal configured to receive the second power voltage.

In an embodiment, the gate driver may be configured to: sequentially provide the write gate signal to pixel rows; and concurrently provide the compensation gate signal to the pixel rows.

According to some embodiments of the present disclosure, a pixel may include (e.g., may only include) three to four transistors and two capacitors, so that the area of the pixel may be reduced.

According to some embodiments of the present disclosure, a display device, and an electronic apparatus including the display device, may include a plurality of pixels, each having a reduced area, so that a resolution of the display device may be increased.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is a block diagram illustrating a display device according to an embodiment.

FIG. 2 is a circuit diagram illustrating an example of a pixel of FIG. 1.

FIG. 3 is a timing diagram illustrating voltages and signals of FIG. 2.

FIGS. 4A-4G are diagrams illustrating an operation of the pixel of FIG. 2.

FIG. 5 is a circuit diagram illustrating an example of a pixel of FIG. 1.

FIG. 6 is a circuit diagram illustrating an example of a pixel of FIG. 1.

FIG. 7 is a timing diagram illustrating voltages and signals of FIG. 6.

FIGS. 8A-8E are diagrams illustrating an operation of the pixel of FIG. 6.

FIG. 9 is a circuit diagram illustrating an example of a pixel of FIG. 1.

FIG. 10 is a block diagram illustrating a display device according to an embodiment.

FIG. 11 is a circuit diagram illustrating an example of a pixel of FIG. 10.

FIG. 12 is a timing diagram illustrating voltages and signals of FIG. 11.

FIGS. 13A-13E are diagrams illustrating an operation of the pixel of FIG. 11.

FIG. 14 is a circuit diagram illustrating an example of a pixel of FIG. 10.

FIG. 15 is a timing diagram illustrating voltages and signals of FIG. 14.

FIG. 16A-16E are diagrams illustrating an operation of the pixel of FIG. 14.

FIG. 17 is a block diagram illustrating an electronic apparatus according to an embodiment.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

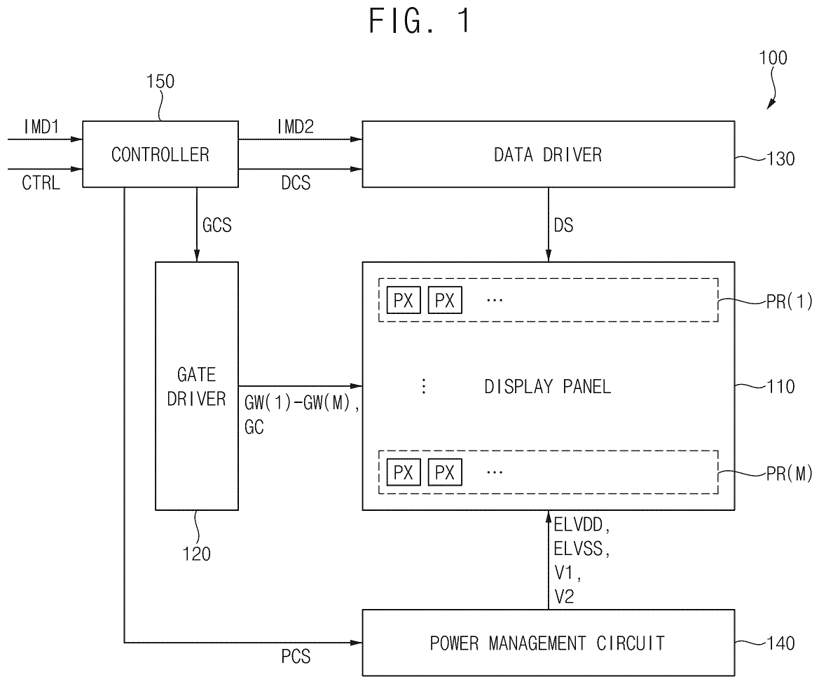

FIG. 1 is a block diagram illustrating a display device 100 according to an embodiment.

Referring to FIG. 1, the display device 100 may include a display panel 110, a gate driver 120, a data driver 130, a power management circuit 140, and a controller 150.

The display panel 110 may include a plurality of pixels PX. The display panel 110 may include first to M^{th} pixel rows PR(1)-PR(M) defined by the pixels PX, where M is a natural number greater than 1.

The gate driver 120 may provide first to M^{th} write gate signals GW(1)-GW(M) and a compensation gate signal GC to the pixels PX. The gate driver 120 may generate the first to M^{th} write gate signals GW(1)-GW(M) and the compensation gate signal GC based on a gate control signal GCS. The gate control signal GCS may include a gate clock signal, a gate start signal, and the like.

The gate driver 120 may sequentially provide the first to M^{th} write gate signals GW(1)-GW(M) to the first to M^{th} pixel rows PR(1)-PR(M). In other words, the gate driver 120 may provide the first write gate signal GW(1) to the first pixel row PR(1), and may provide the M^{th} write gate signal GW(M) to the M^{th} pixel row PR(M). The gate driver 120 may concurrently (e.g., simultaneously or substantially simultaneously) provide the compensation gate signal GC to the first to M^{th} pixel rows PR(1)-PR(M).

The data driver 130 may provide data signals DS to the pixels PX. The data driver 130 may generate the data signals DS based on output image data IMD2 and a data control signal DCS. The data driver 130 may convert the output image data IMD2 in a digital form into the data signals DS in an analog form. The data control signal DCS may include a data clock signal, a load signal, an output data enable signal, and the like.

The power management circuit 140 may provide a first power voltage ELVDD, a second power voltage ELVSS, a first voltage V1, and a second voltage V2 to the pixels PX. The power management circuit 140 may generate the first power voltage ELVDD, the second power voltage ELVSS, the first voltage V1, and the second voltage V2 based on a power control signal PCS. The power management circuit 140 may concurrently (e.g., simultaneously or substantially simultaneously) provide the first power voltage ELVDD, the second power voltage ELVSS, the first voltage V1, and the second voltage V2 to the first to M^{th} pixel rows PR(1)-PR(M).

The controller 150 may control the gate driver 120, the data driver 130, and the power management circuit 140. The controller 150 may provide the gate control signal GCS to the gate driver 120, may provide the output image data IMD2 and the data control signal DCS to the data driver 130, and may provide the power control signal PCS to the power management circuit 140. The controller 150 may convert input image data IMD1 into the output image data IMD2. The controller 150 may generate the gate control signal GCS, the data control signal DCS, and the power control signal PCS based on a control signal CTRL. The control signal CTRL may include a vertical synchronization signal, a horizontal synchronization signal, a master clock signal, an input data enable signal, and the like.

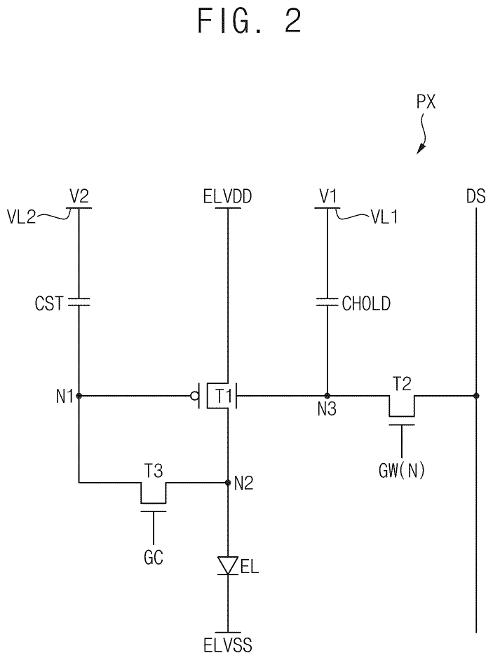

FIG. 2 is a circuit diagram illustrating an example of the pixel PX of FIG. 1.

Referring to FIGS. 1 and 2, the pixel PX may receive a write gate signal GW(N), the compensation gate signal GC, a data signal DS, the first power voltage ELVDD, the second power voltage ELVSS, the first voltage V1, and the second voltage V2, where N is a natural number greater than or equal to 1 and less than or equal to M. The write gate signal GW(N) may be one of the first to M^{th} write gate signals GW(1)-GW(M).

The pixel PX may include a first transistor T1, a second transistor T2, a third transistor T3, a first capacitor CHOLD, a second capacitor CST, and a light-emitting element EL.

The first transistor T1 may include a gate connected to a first node N1, a first terminal that receives the first power voltage ELVDD, a second terminal connected to a second node N2, and a body (e.g., a back gate) connected to a third node N3. The first transistor T1 may generate a driving current based on a voltage of the first node N1 and a voltage of the third node N3.

The second transistor T2 may transmit the data signal DS to the third node N3 in response to the write gate signal GW(N). The second transistor T2 may include a gate that receives the write gate signal GW(N), a first terminal that receives the data signal DS, and a second terminal connected to the third node N3.

The third transistor T3 may connect the first node N1 to the second node N2 in response to the compensation gate signal GC. The third transistor T3 may include a gate that receives the compensation gate signal GC, a first terminal connected to the first node N1, and a second terminal connected to the second node N2.

The first transistor T1 may be a p-type metal oxide semiconductor (PMOS) transistor, and each of the second transistor T2 and the third transistor T3 may be an n-type metal oxide semiconductor (NMOS) transistor. The first transistor T1 may be a polycrystalline silicon transistor, and each of the second transistor T2 and the third transistor T3 may be an oxide semiconductor transistor.

The first capacitor CHOLD may be connected between the third node N3 and a first voltage line VL1 that transmits the first voltage V1. The first capacitor CHOLD may include a first terminal connected to the third node N3, and a second terminal that receives the first voltage V1. The first capacitor CHOLD may store a voltage difference between the third node N3 and the first voltage line VL1.

The second capacitor CST may be connected between the first node N1 and a second voltage line VL2 that transmits the second voltage V2. The second capacitor CST may include a first terminal connected to the first node N1, and a second terminal that receives the second voltage V2. The second capacitor CST may store a voltage difference between the first node N1 and the second voltage line VL2.

The light-emitting element EL may include a first terminal (e.g., an anode) connected to the second node N2, and a second terminal (e.g., a cathode) that receives the second power voltage ELVSS. The light-emitting element EL may emit light having a luminance corresponding to the driving current generated by the first transistor T1.

The pixel PX according to some embodiments of the present disclosure includes three transistors and two capacitors (e.g., only three transistors and two capacitors), so that an area of the pixel PX may be reduced. Further, the display device 100 according to some embodiments of the present disclosure includes the pixels PX having a smaller area, so that a resolution of the display device 100 may be increased.

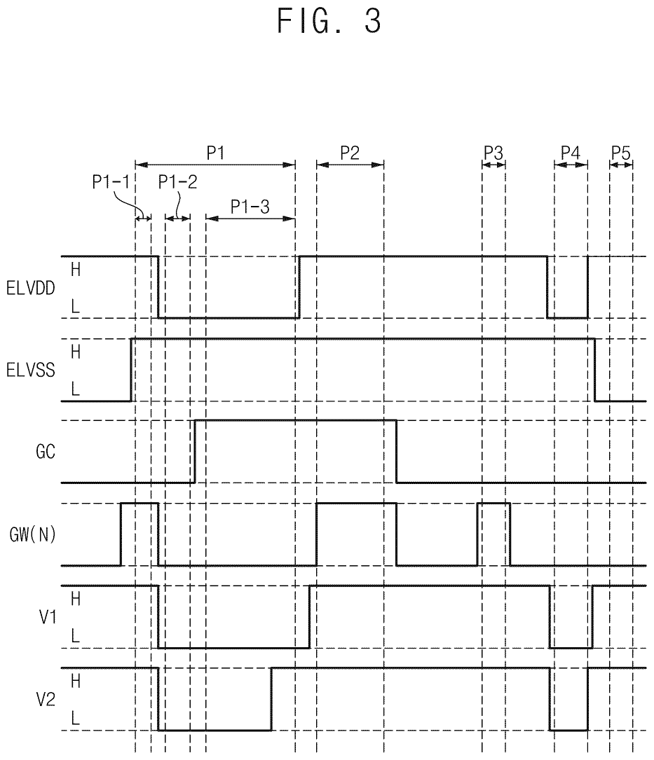

FIG. 3 is a timing diagram illustrating the voltages ELVDD, ELVSS, V1, and V2 and the signals GC and GW(N) of FIG. 2.

Referring to FIGS. 2 and 3, a frame period corresponding to one image frame may include an initialization period P1, a compensation period P2, a writing period P3, a bypass period P4, and an emission period P5. The initialization period P1, the compensation period P2, the writing period P3, the bypass period P4, and the emission period P5 may be sequentially performed. The initialization period P1 may include a third node initialization period P1-1, a second node initialization period P1-2, and a first node initialization period P1-3. The third node initialization period P1-1, the second node initialization period P1-2, and the first node initialization period P1-3 may be sequentially performed.

The first power voltage ELVDD may have a high level H in the third node initialization period P1-1, and may have a low level L in the second node initialization period P1-2 and the first node initialization period P1-3. The first power voltage ELVDD may have the high level H in the compensation period P2 and the writing period P3, may have the low level L in the bypass period P4, and may have the high level H in the emission period P5. The second power voltage ELVSS may have a high level H in the initialization period P1, the compensation period P2, the writing period P3, and the bypass period P4, and may have a low level L in the emission period P5.

The compensation gate signal GC may have a deactivation level in the third node initialization period P1-1 and the second node initialization period P1-2, may have an activation level in the first node initialization period P1-3 and the compensation period P2, and may have the deactivation level in the writing period P3, the bypass period P4, and the emission period P5. The write gate signal GW(N) may have an activation level in the third node initialization period P1-1, may have a deactivation level in the second node initialization period P1-2 and the first node initialization period P1-3, may have the activation level in the compensation period P2 and the writing period P3, and may have the deactivation level in the bypass period P4 and the emission period P5.

The first voltage V1 may have a high level H in the third node initialization period P1-1, may have a low level L in the second node initialization period P1-2 and the first node initialization period P1-3, may have the high level H in the compensation period P2 and the writing period P3, may have the low level L in the bypass period P4, and may have the high level H in the emission period P5. The second voltage V2 may have a high level H in the third node initialization period P1-1, may have a low level L in the second node initialization period P1-2, may transition from the low level L to the high level H in the first node initialization period P1-3, may have the high level H in the compensation period P2 and the writing period P3, may have the low level L in the bypass period P4, and may have the high level H in the emitting period P5.

In an embodiment, the high level H of the first power voltage ELVDD, the high level H of the second power voltage ELVSS, the high level H of the first voltage V1, and the high level H of the second voltage V2 may be equal to or substantially equal to each other, and the low level L of the first power voltage ELVDD, the low level L of the second power voltage ELVSS, the low level L of the first voltage V1, and the low level L of the second voltage V2 may be equal to or substantially equal to each other. In an embodiment, at least one of the high level H of the first power voltage ELVDD, the high level H of the second power voltage ELVSS, the high level H of the first voltage V1, or the high level H of the second voltage V2 may be different from the rest, and at least one of the low level L of the first power voltage ELVDD, the low level L of the second power voltage ELVSS, the low level L of the first voltage V1, or the low level L of the second voltage V2 may be different from the rest.

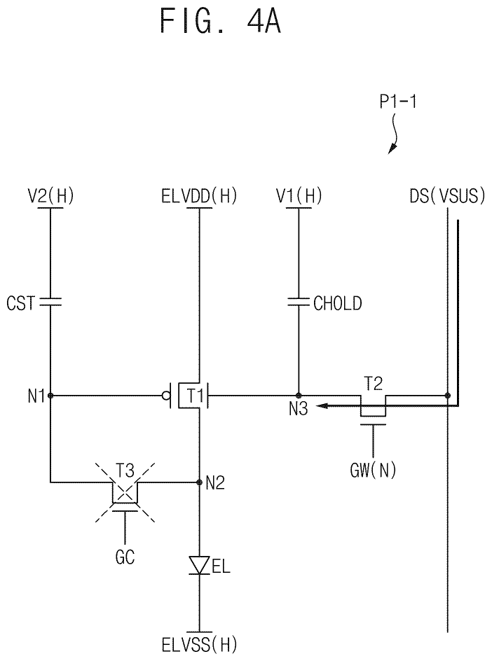

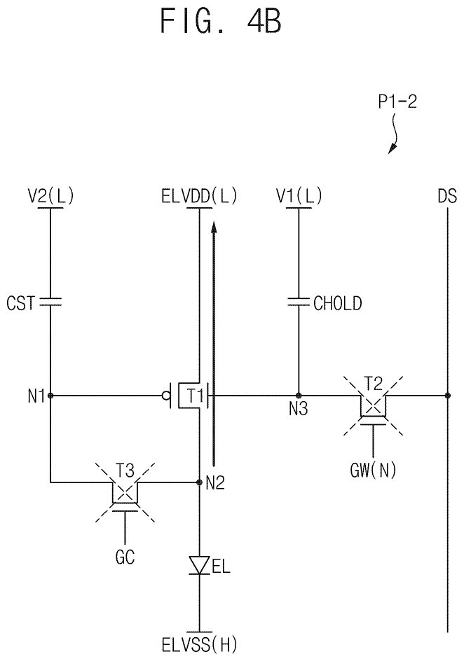

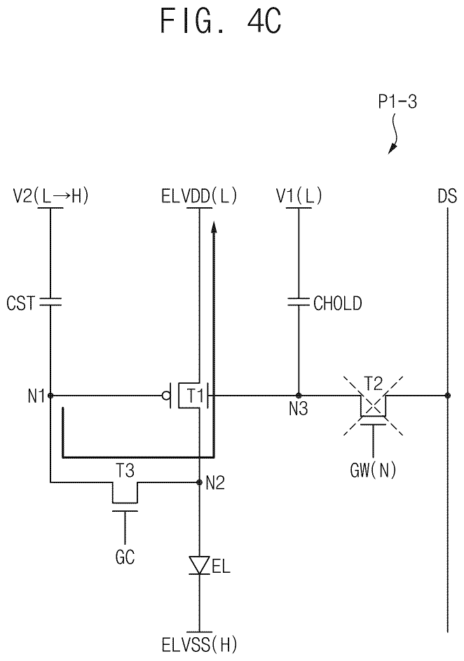

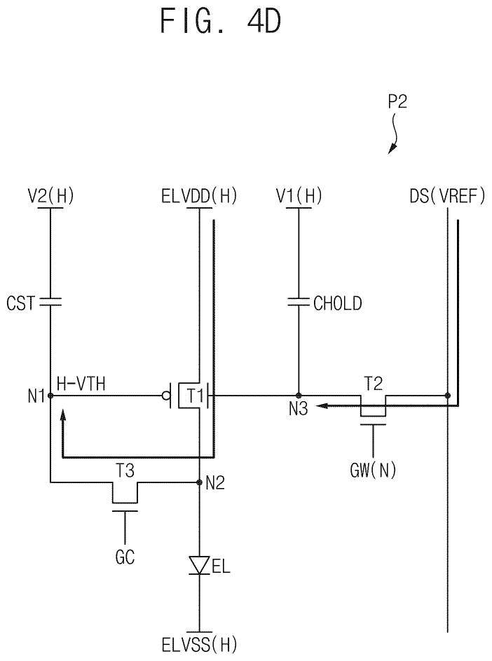

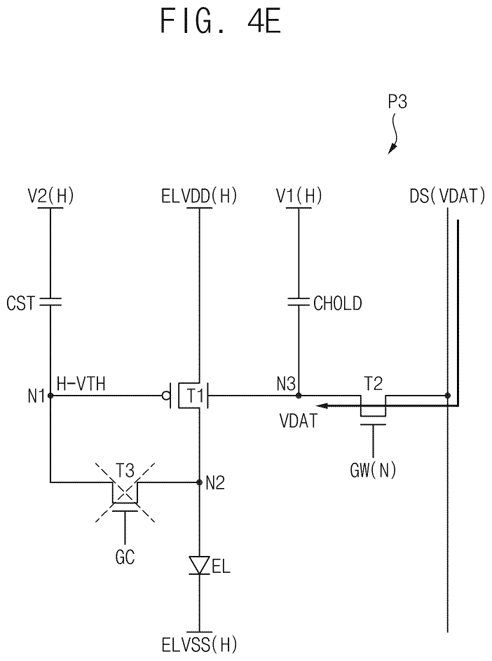

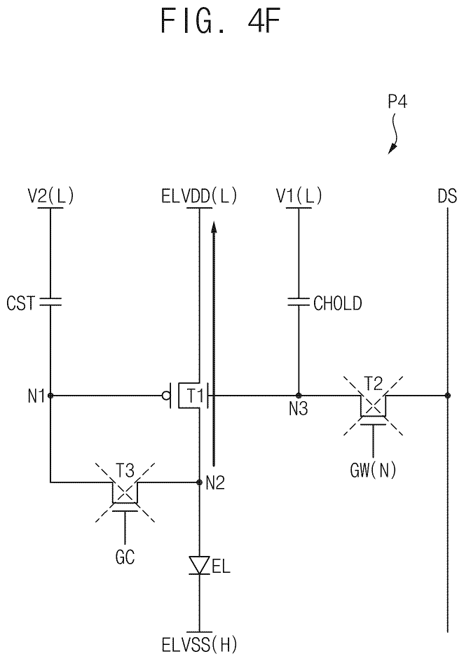

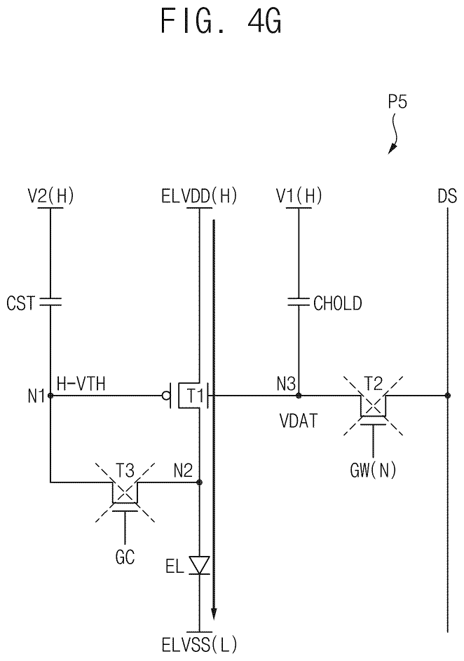

The data signal DS may have a sustain voltage VSUS (e.g., see FIG. 4A) in the third node initialization period P1-1, a reference voltage VREF (e.g., see FIG. 4D) in the compensation period P2, and a data voltage VDAT (e.g., see FIG. 4E) in the writing period P3.

FIGS. 4A through 4G are diagrams illustrating an operation of the pixel PX of FIG. 2.

Referring to FIGS. 3 and 4A, in the third node initialization period P1-1, the second transistor T2 may be turned on in response to the write gate signal GW(N) having the activation level, and the sustain voltage VSUS may be applied to the third node N3 through the second transistor T2. Accordingly, in the third node initialization period P1-1, the third node N3 (e.g., the body of the first transistor T1) may be initialized by the sustain voltage VSUS.

Referring to FIGS. 3 and 4B, in the second node initialization period P1-2, the first power voltage ELVDD having the low level L may be applied to the second node N2 through the first transistor T1. Accordingly, in the second node initialization period P1-2, the second node N2 (e.g., the first terminal of the light-emitting element EL) may be initialized by the low level L of the first power voltage ELVDD.

Referring to FIGS. 3 and 4C, in the first node initialization period P1-3, the third transistor T3 may be turned on in response to the compensation gate signal GC having the activation level, and the first power voltage ELVDD having the low level L 1 may be applied to the first node N1 through the first transistor T1 and the third transistor T3. Accordingly, in the first node initialization period P1-3, the first node N1 (e.g., the first terminal of the second capacitor CST) may be initialized by the low level L of the first power voltage ELVDD.

Referring to FIGS. 3 and 4D, in the compensation period P2, the second transistor T2 may be turned on in response to the write gate signal GW(N) having the activation level, and the reference voltage VREF may be applied to the third node N3 through the second transistor T2. Further, the third transistor T3 may be turned on in response to the compensation gate signal GC having the activation level, and a voltage H-VTH corresponding to a value obtained by subtracting a threshold voltage VTH of the first transistor T1 from the high level H of the first power voltage ELVDD may be applied to the first node N1 through the first transistor T1 and the third transistor T3. Accordingly, in the compensation period P2, the second capacitor CST may store the threshold voltage VTH of the first transistor T1.

Referring to FIGS. 3 and 4E, in the writing period P3, the second transistor T2 may be turned on in response to the write gate signal GW(N) having the activation level, and the data voltage VDAT may be applied to the third node N3 through the second transistor T2. Accordingly, the data voltage VDAT may be stored in the third node N3 in the writing period P3.

Referring to FIGS. 3 and 4F, in the bypass period P4, the first power voltage ELVDD having the low level L may be applied to the second node N2 through the first transistor T1. Accordingly, in the bypass period P4, charges stored in the first terminal of the light-emitting element EL by a parasitic capacitance of the light-emitting element EL may be discharged to a line that transmits the first power voltage ELVDD through the first transistor T1.

Referring to FIGS. 3 and 4G, in the emission period P5, the driving current generated by the first transistor T1 may flow through the light-emitting element EL. The light-emitting element EL may emit light having a luminance corresponding to the magnitude of the driving current. Because the second capacitor CST connected to the gate of the first transistor T1 stores the threshold voltage VTH of the first transistor T1, the threshold voltage VTH of the first transistor T1 may be compensated for, and a gate-source voltage (e.g., a voltage difference between the gate and the first terminal of the first transistor T1) of the first transistor T1 may be fixed. Further, the threshold voltage VTH of the first transistor T1 may be controlled according to a voltage of the body of the first transistor T1, and the magnitude of the driving current generated by the first transistor T1 may be controlled according to the threshold voltage VTH of the first transistor T1. Accordingly, in the emission period P5, the light-emitting element EL may emit light having a luminance corresponding to the data voltage VDAT, which is the voltage of the body of the first transistor T1.

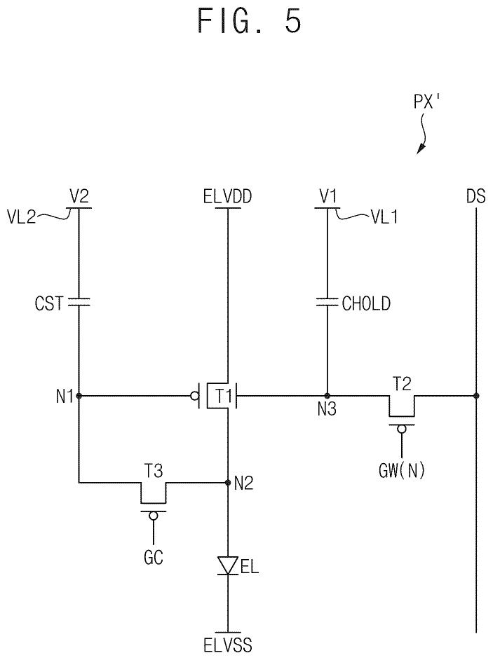

FIG. 5 is a circuit diagram illustrating an example of a pixel PX′ of FIG. 1.

Hereinafter with reference to FIG. 5, redundant description of the pixel PX′, which are the same or substantially the same as (or similar to) those of the pixel PX described above with reference to FIG. 2, may not be repeated.

Referring to FIG. 5, the first transistor T1 may be a PMOS transistor, and at least one of the second transistor T2 or the third transistor T3 may also be a PMOS transistor. In an embodiment, as illustrated in FIG. 5, each of the first transistor T1, the second transistor T2, and the third transistor T3 may be a PMOS transistor. Each of the first transistor T1, the second transistor T2, and the third transistor T3 may be a polycrystalline silicon transistor.

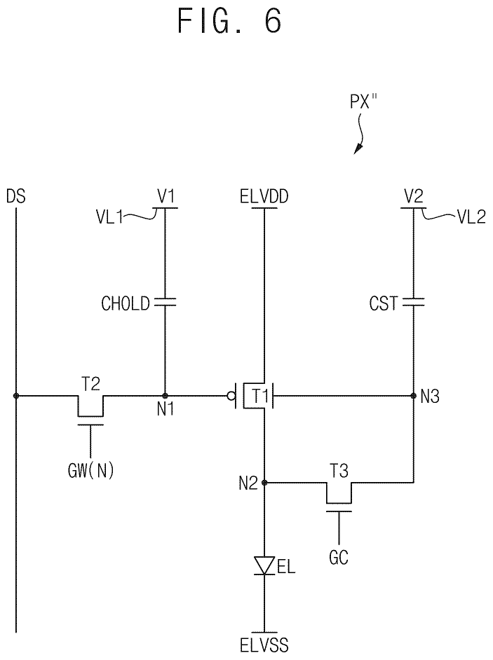

FIG. 6 is a circuit diagram illustrating an example of a pixel PX″ of FIG. 1.

Hereinafter with reference to FIG. 6, redundant description of the pixel PX″, which are the same or substantially the same as (or similar to) those of the pixel PX described above with reference to FIG. 2, may not be repeated.

Referring to FIGS. 1 and 6, the second transistor T2 may transmit the data signal DS to the first node N1 in response to the write gate signal GW(N). The second transistor T2 may include a gate that receives the write gate signal GW(N), a first 1 terminal that receives the data signal DS, and a second terminal connected to the first node N1.

The third transistor T3 may connect the second node N2 to the third node N3 in response to the compensation gate signal GC. The third transistor T3 may include a gate that receives the compensation gate signal GC, a first terminal connected to the second node N2, and a second terminal connected to the third node N3.

The first transistor T1 may be a PMOS transistor, and each of the second transistor T2 and the third transistor T3 may be an NMOS transistor. The first transistor T1 may be a polycrystalline silicon transistor, and each of the second transistor T2 and the third transistor T3 may be an oxide semiconductor transistor.

The first capacitor CHOLD may be connected between the first node N1 and the first voltage line VL1 that transmits the first voltage V1. The first capacitor CHOLD may include a first terminal connected to the first node N1, and a second terminal that receives the first voltage V1. The first capacitor CHOLD may store a voltage difference between the first node N1 and the first voltage line VL1.

The second capacitor CST may be connected between the third node N3 and the second voltage line VL2 that transmits the second voltage V2. The second capacitor CST may include a first terminal connected to the third node N3, and a second terminal that receives the second voltage V2. The second capacitor CST may store a voltage difference between the third node N3 and the second voltage line VL2.

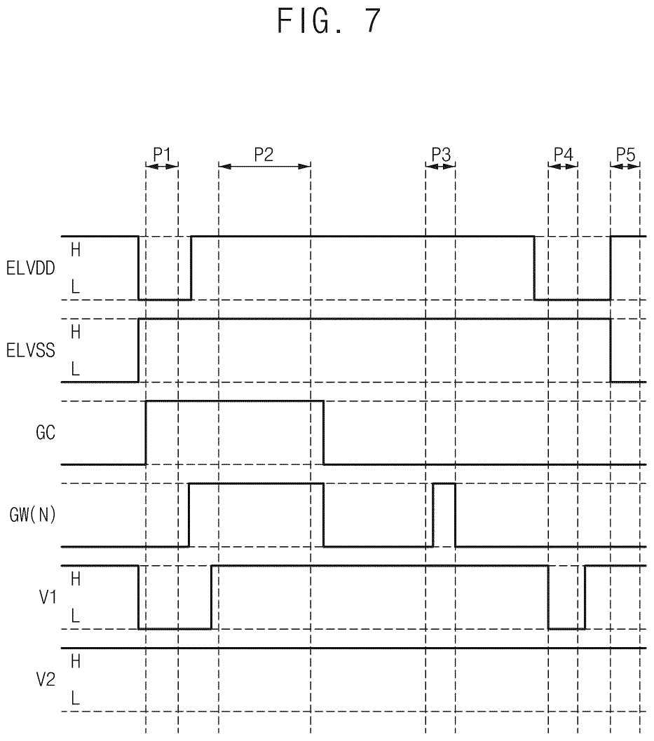

FIG. 7 is a timing diagram illustrating the voltages ELVDD, ELVSS, V1, and V2 and the signals GC and GW(N) of FIG. 6.

Referring to FIGS. 6 and 7, a frame period corresponding to one image frame may include an initialization period P1, a compensation period P2, a writing period P3, a bypass period P4, and an emission period P5. The initialization period P1, the compensation period P2, the writing period P3, the bypass period P4, and the emission period P5 may be sequentially performed.

The first power voltage ELVDD may have a low level L in the initialization period P1, may have a high level H in the compensation period P2 and the writing period P3, may have the low level L in the bypass period P4, and may have the high level H in the emission period P5. The second power voltage ELVSS may have a high level H in the initialization period P1, the compensation period P2, the writing period P3, and the bypass period P4, and may have a low level L in the emission period P5.

The compensation gate signal GC may have an activation level in the initialization period P1 and the compensation period P2, and may have a deactivation level in the writing period P3, the bypass period P4, and the emission period P5. The write gate signal GW(N) may have a deactivation level in the initialization period P1, may have an activation level in the compensation period P2 and the writing period P3, and may have the deactivation level in the bypass period P4 and the emission period P5.

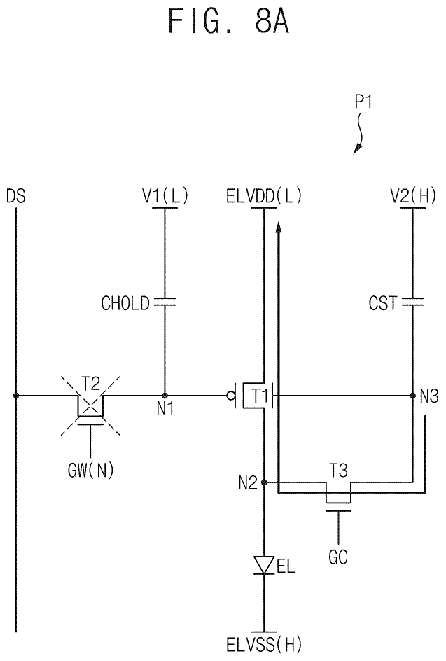

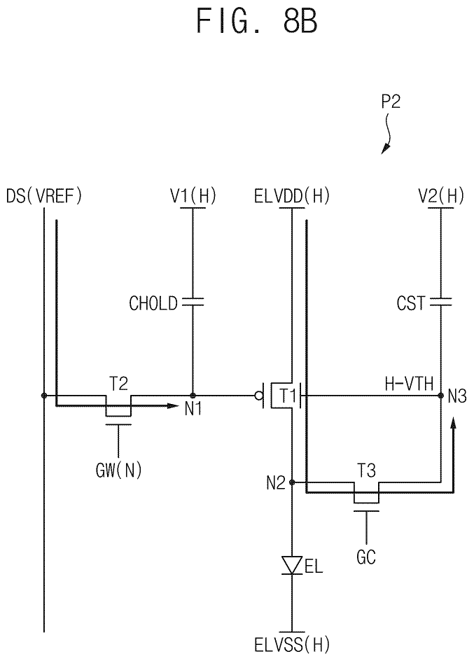

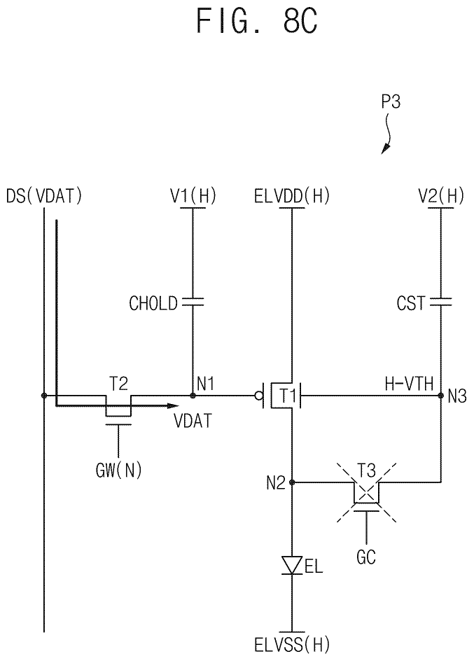

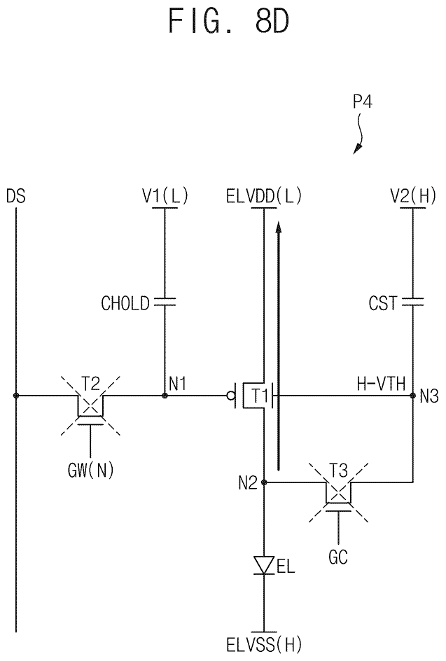

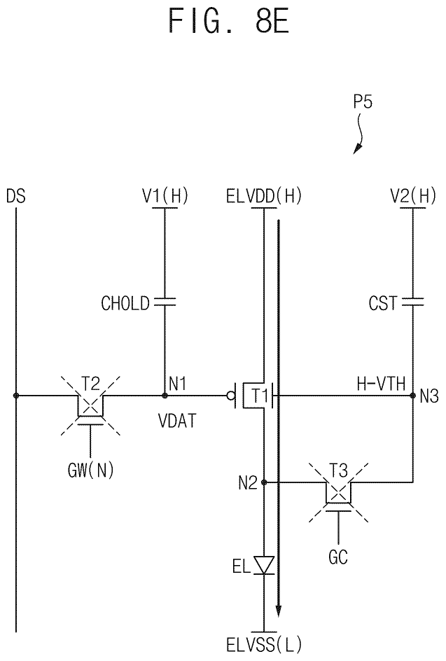

The first voltage V1 may have a low level L in the initialization period P1, may have a high level H in the compensation period P2 and the writing period P3, may have the low level L in the bypass period P4, and may have the high level H in the emission period P5. The second voltage V2 may have a high level H in the initialization period P1, the compensation period P2, the writing period P3, the bypass period P4, and the emission period P5. The second voltage V2 may be a direct current (DC) voltage. The data signal DS may have a reference voltage VREF (e.g., see FIG. 8B) in the compensation period P2, and may have a data voltage VDAT (e.g., see FIG. 8C) in the writing period P3.

FIGS. 8A through 8E are diagrams illustrating an operation of the pixel PX″ of FIG. 6.

Referring to FIGS. 7 and 8A in the initialization period P1, the third transistor T3 may be turned on in response to the compensation gate signal GC having the activation level, and the first power voltage ELVDD having the low level L may be applied to the second node N2 and the third node N3 through the first transistor T1 and the third transistor T3. Accordingly, in the initialization period P1, the second node N2 (e.g., the first terminal of the light-emitting element EL) and the third node N3 (e.g., the body of the first transistor T1 and the first terminal of the second capacitor CST) may be initialized by the low level L of the first power voltage ELVDD.

Referring to FIGS. 7 and 8B, in the compensation period P2, the second transistor T2 may be turned on in response to the write gate signal GW(N) having the activation level, and the reference voltage VREF may be applied to the first node N1 through the second transistor T2. Further, the third transistor T3 may be turned on in response to the compensation gate signal GC having the activation level, and a voltage H-VTH corresponding to a value obtained by subtracting a threshold voltage VTH of the first transistor T1 from the high level H of the first power voltage ELVDD may be applied to the third node N3 through the first transistor T1 and the third transistor T3. Accordingly, in the compensation period P2, the second capacitor CST may store the threshold voltage VTH of the first transistor T1.

Referring to FIGS. 7 and 8C, in the writing period P3, the second transistor T2 may be turned on in response to the write gate signal GW(N) having the activation level, and the data voltage VDAT may be applied to the first node N1 through the second transistor T2. Accordingly, the data voltage VDAT may be stored in the first node N1 in the writing period P3.

Referring to FIGS. 7 and 8D, in the bypass period P4, the first power voltage ELVDD having the low level L may be applied to the second node N2 through the first transistor T1. Accordingly, in the bypass period P4, charges stored in the first terminal of the light-emitting element EL by a parasitic capacitance of the light-emitting element EL may be discharged to a line that transmits the first power voltage ELVDD through the first transistor T1.

Referring to FIGS. 7 and 8E, in the emission period P5, the driving current generated by the first transistor T1 may flow through the light-emitting element EL. The light-emitting element EL may emit light having a luminance corresponding to the magnitude of the driving current. Because the second capacitor CST connected to the body of the first transistor T1 stores the threshold voltage VTH of the first transistor T1, a voltage of the body of the first transistor T1 may be fixed, and a threshold voltage deviation or variation between the first transistors T1 of the pixels PX may not occur. In other words, although the threshold voltages VTH of the first transistors T1 of the pixels PX may be different from each other, because voltages reflecting the threshold voltages VTH of the first transistors T1 are applied to the bodies of the first transistors T1, the threshold voltages VTH of the first transistors T1 of the pixels PX may become equal or substantially equal to each other. Further, the magnitude of the driving current generated by the first transistor T1 may be controlled according to the gate-source voltage of the first transistor T1. Accordingly, in the emission period P5, the light-emitting element EL may emit light having a luminance corresponding to the data voltage VDAT, which is a voltage of the gate of the first transistor T1.

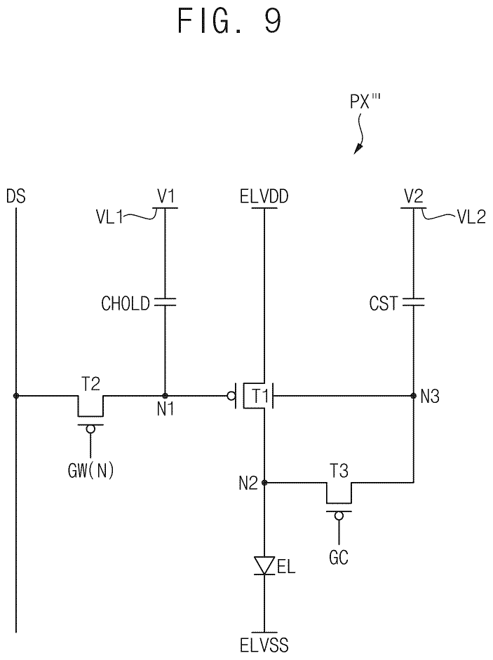

FIG. 9 is a circuit diagram illustrating an example of a pixel PX″ of FIG. 1.

Hereinafter with reference to FIG. 9, redundant description of the PX″, which are the same or substantially the same as (or similar to) those of the pixel PX″ described above with reference to FIG. 6, may not be repeated.

Referring to FIG. 9, the first transistor T1 may be a PMOS transistor, and at least one of the second transistor T2 or the third transistor T3 may be a PMOS transistor. In an embodiment, as illustrated in FIG. 9, each of the first transistor T1, the second transistor T2, and the third transistor T3 may be a PMOS transistor. Each of the first transistor T1, the second transistor T2, and the third transistor T3 may be a polycrystalline silicon transistor.

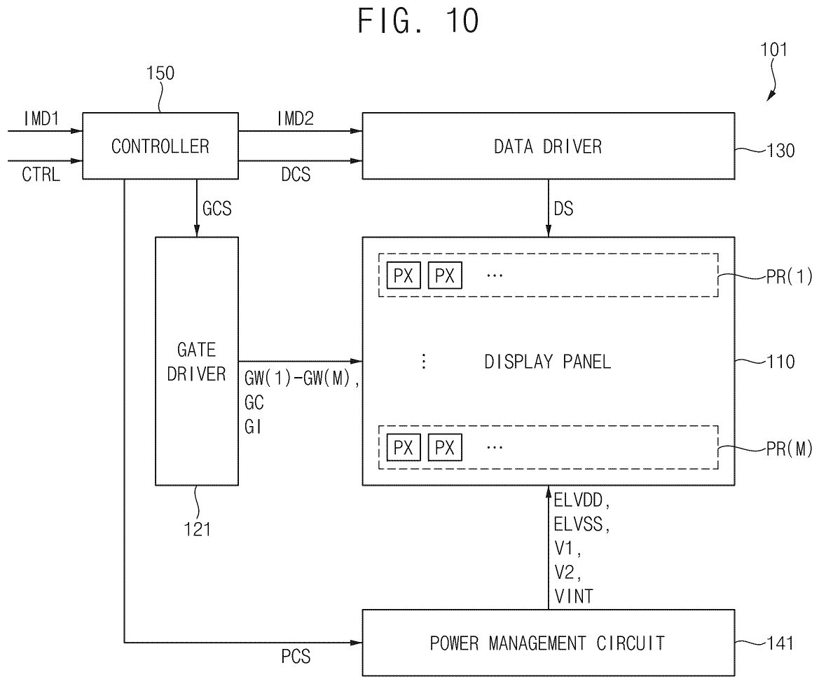

FIG. 10 is a block diagram illustrating a display device 101 according to an embodiment.

Hereinafter with reference to FIG. 10, redundant description of the display device 101, which are the same or substantially the same as (or similar to) those of the display device 100 described above with reference to FIG. 1, may not be repeated.

Referring to FIG. 10, the display device 101 may include a display panel 110, a gate driver 121, a data driver 130, a power management circuit 141, and a controller 150.

The gate driver 121 may provide first to M^{th} write gate signals GW(1)-GW(M), a compensation gate signal GC, and an initialization gate signal GI to the pixels PX, where M is a natural number greater than 1. The gate driver 121 may generate the first to M^{th} write gate signals GW(1)-GW(M), the compensation gate signal GC, and the initialization gate signal GI based on a gate control signal GCS. The gate driver 121 may concurrently (e.g., simultaneously or substantially simultaneously) provide the initialization gate signal GI to the first to M^{th} pixel rows PR(1)-PR(M).

The power management circuit 141 may provide a first power voltage ELVDD, a second power voltage ELVSS, a first voltage V1, a second voltage V2, and an initialization voltage VINT to the pixels PX. The power management circuit 141 may generate the first power voltage ELVDD, the second power voltage ELVSS, the first voltage V1, the second voltage V2, and the initialization voltage VINT based on a power control signal PCS. The power management circuit 141 may concurrently (e.g., simultaneously or substantially simultaneously) provide the initialization voltage VINT to the first to M^{th} pixel rows PR(1)-PR(M).

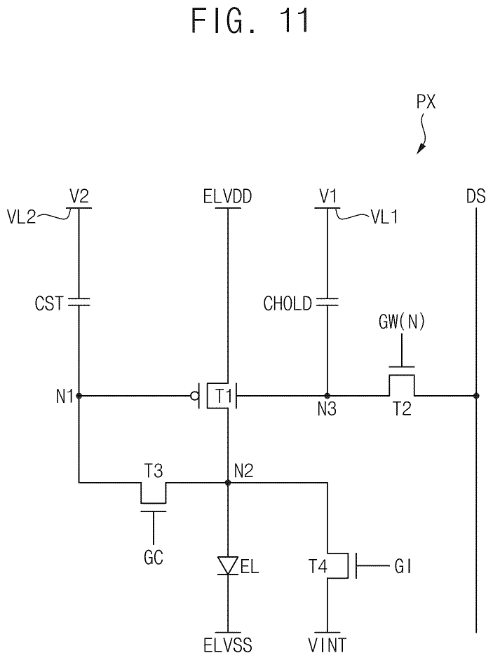

FIG. 11 is a circuit diagram illustrating an example of the pixel PX of FIG. 10.

Hereinafter with reference to FIG. 11, redundant description of the pixel PX, which are the same or substantially the same as (or similar to) those of the pixel PX described above with reference to FIG. 2, may not be repeated.

Referring to FIGS. 10 and 11, the pixel PX may receive a write gate signal GW(N), the compensation gate signal GC, the initialization gate signal GI, a data signal DS, the first power voltage ELVDD, the second power voltage ELVSS, the first voltage V1, the second voltage V2, and the initialization voltage VINT.

The pixel PX may include a first transistor T1, a second transistor T2, a third transistor T3, a fourth transistor T4, a first capacitor CHOLD, a second capacitor CST, and a light-emitting element EL.

The fourth transistor T4 may transmit the initialization voltage VINT to the second node N2 in response to the initialization gate signal GI. The fourth transistor T4 may include a gate that receives the initialization gate signal GI, a first terminal that receives the initialization voltage VINT, and a second terminal connected to the second node N2.

The first transistor T1 may be a PMOS transistor, and each of the second transistor T2, the third transistor T3, and the fourth transistor T4 may be an NMOS transistor. The first transistor T1 may be a polycrystalline silicon transistor, and each of the second transistor T2, the third transistor T3, and the fourth transistor T4 may be an oxide semiconductor transistor.

The pixel PX according to the present embodiment includes four transistors and two capacitors (e.g., only four transistors and two capacitors), so that an area of the pixel PX may be reduced. Further, the display device 101 according to the present embodiment includes the pixels PX having a smaller area, so that a resolution of the display device 101 may be increased.

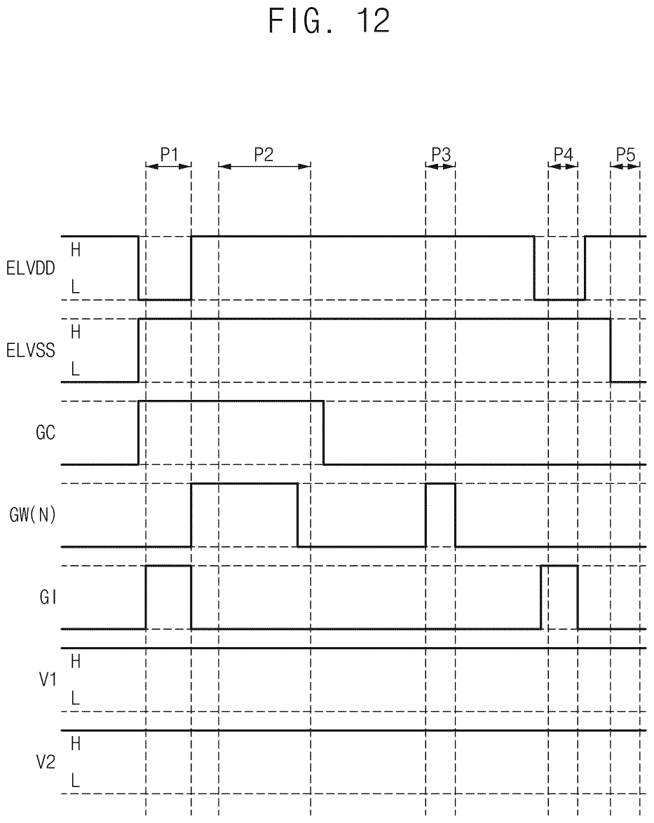

FIG. 12 is a timing diagram illustrating the voltages ELVDD, ELVSS, V1, and V2 and the signals GC, GW(N), and GI of FIG. 11.

Hereinafter with reference to FIG. 12, redundant description of the voltages ELVDD, ELVSS, V1, and V2 and the signals GC, GW(N), and GI, which are the same or substantially the same as (or similar to) those of the voltages ELVDD, ELVSS, V1, and V2 and the signals GC and GW(N) described above with reference to FIG. 7, may not be repeated.

Referring to FIGS. 11 and 12, the initialization gate signal GI may have an activation level in the initialization period P1, may have a deactivation level in the 1 compensation period P2 and the writing period P3, may have the activation level in the bypass period P4, and may have the deactivation level in the emission period P5.

The first voltage V1 may have a high level H in the initialization period P1, the compensation period P2, the writing period P3, the bypass period P4, and the emission period P5. The first voltage V1 may be a DC voltage.

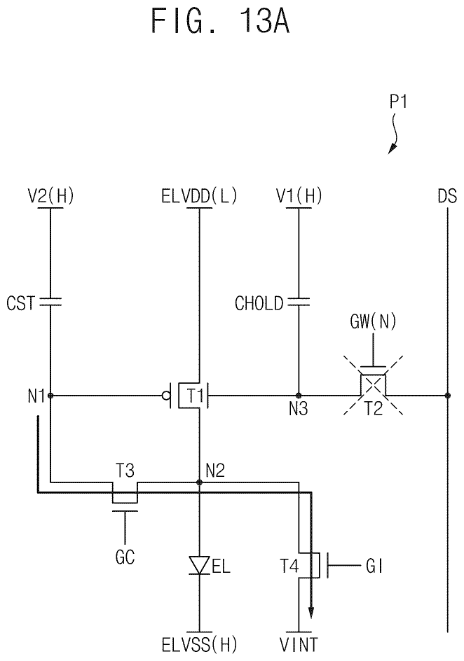

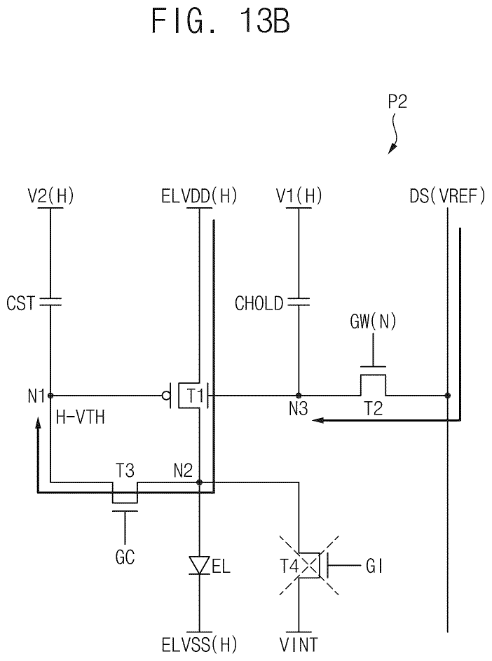

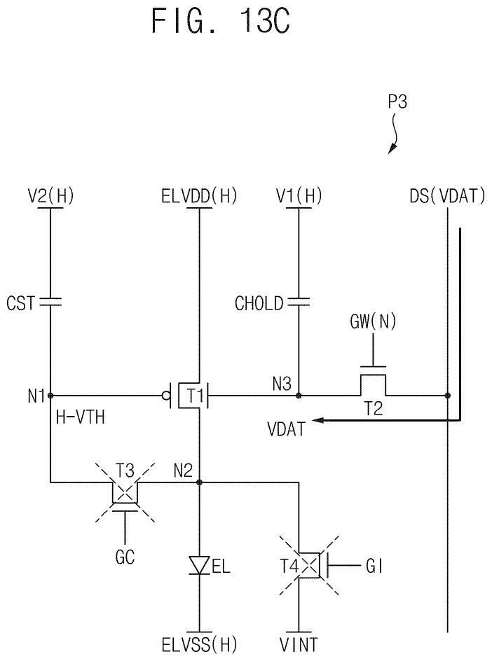

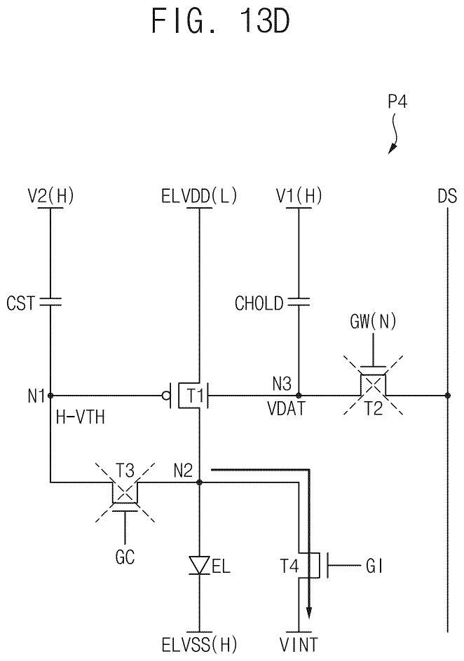

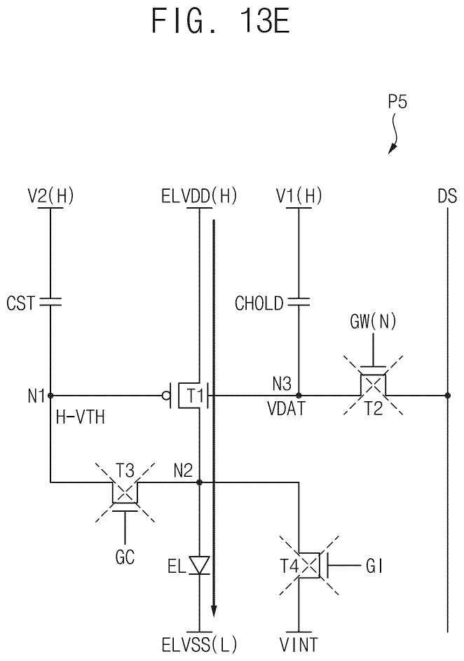

FIG. 13A through 13E are diagrams illustrating an operation of the pixel PX of FIG. 11.

Referring to FIGS. 12 and 13A, in the initialization period P1, the third transistor T3 may be turned on in response to the compensation gate signal GC having the activation level, the fourth transistor T4 may be turned on in response to the initialization gate signal GI having the activation level, and the initialization voltage VINT may be applied to the second node N2 and the first node N1 through the fourth transistor T4 and the third transistor T3. Accordingly, in the initialization period P1, the second node N2 (e.g., the first terminal of the light-emitting element EL) and the first node N1 (e.g., the first terminal of the second capacitor CST) may be initialized by the initialization voltage VINT.

Referring to FIGS. 12 and 13B, in the compensation period P2, the second transistor T2 may be turned on in response to the write gate signal GW(N) having the activation level, and the reference voltage VREF may be applied to the third node N3 through the second transistor T2. Further, the third transistor T3 may be turned on in response to the compensation gate signal GC having the activation level, and a voltage H-VTH corresponding to a value obtained by subtracting a threshold voltage VTH of the first transistor T1 from the high level H of the first power voltage ELVDD may be applied to the first node N1 through the first transistor T1 and the third transistor T3. Accordingly, in the compensation period P2, the second capacitor CST may store the threshold voltage VTH of the first transistor T1.

Referring to FIGS. 12 and 13C, in the writing period P3, the second transistor T2 may be turned on in response to the write gate signal GW(N) having the 1 activation level, and the data voltage VDAT may be applied to the third node N3 through the second transistor T2. Accordingly, the data voltage VDAT may be stored in the third node N3 in the writing period P3.

Referring to FIGS. 12 and 13D, in the bypass period P4, the fourth transistor T4 may be turned on in response to the initialization gate signal GI having the activation level, and the initialization voltage VINT may be applied to the second node N2 through the fourth transistor T4. Accordingly, in the bypass period P4, charges stored in the first terminal of the light-emitting element EL by a parasitic capacitance of the light-emitting element EL may be discharged to a line that transmits the initialization voltage VINT through the fourth transistor T4.

Referring to FIGS. 12 and 13E, the driving current generated by the first transistor T1 may flow through the light-emitting element EL. The light-emitting element EL may emit light having a luminance corresponding to the magnitude of the driving current. Because the second capacitor CST connected to the gate of the first transistor T1 stores the threshold voltage VTH of the first transistor T1, the threshold voltage VTH of the first transistor T1 may be compensated for, and a gate-source voltage of the first transistor T1 may be fixed. Further, the threshold voltage VTH of the first transistor T1 may be controlled according to a voltage of the body of the first transistor T1, and the magnitude of the driving current generated by the first transistor T1 may be controlled according to the threshold voltage VTH of the first transistor T1. Accordingly, in the emission period P5, the light-emitting element EL may emit light having a luminance corresponding to the data voltage VDAT, which is the voltage of the body of the first transistor T1.

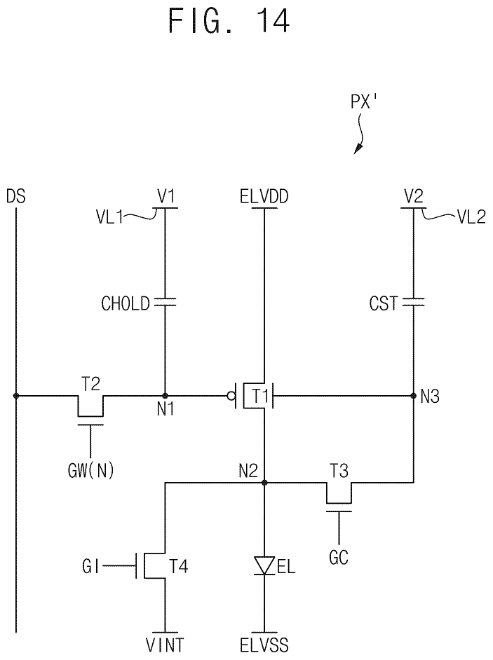

FIG. 14 is a circuit diagram illustrating an example of a pixel PX′ of FIG. 10.

Hereinafter with reference to FIG. 14, redundant description of the pixel PX′, which are the same or substantially the same as (or similar to) those of the pixel PX″ described above with reference to FIG. 6, may not be repeated.

Referring to FIGS. 10 and 14, the pixel PX′ may receive a write gate signal GW(N), the compensation gate signal GC, the initialization gate signal GI, a data signal DS, the first power voltage ELVDD, the second power voltage ELVSS, the first voltage V1, the second voltage V2, and the initialization voltage VINT.

The pixel PX′ may include a first transistor T1, a second transistor T2, a third transistor T3, a fourth transistor T4, a first capacitor CHOLD, a second capacitor CST, and a light-emitting element EL.

The fourth transistor T4 may transmit the initialization voltage VINT to the second node N2 in response to the initialization gate signal GI. The fourth transistor T4 may include a gate that receives the initialization gate signal GI, a first terminal that receives the initialization voltage VINT, and a second terminal connected to the second node N2.

The first transistor T1 may be a PMOS transistor, and each of the second transistor T2, the third transistor T3, and the fourth transistor T4 may be an NMOS transistor. The first transistor T1 may be a polycrystalline silicon transistor, and each of the second transistor T2, the third transistor T3, and the fourth transistor T4 may be an oxide semiconductor transistor.

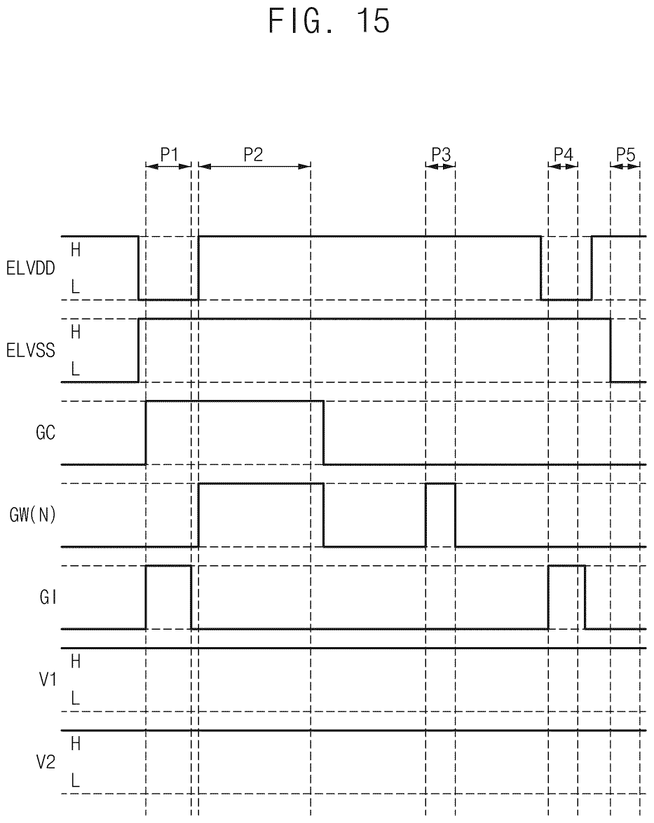

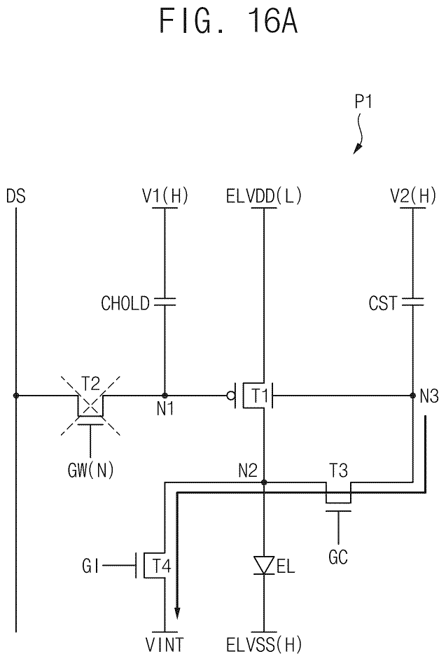

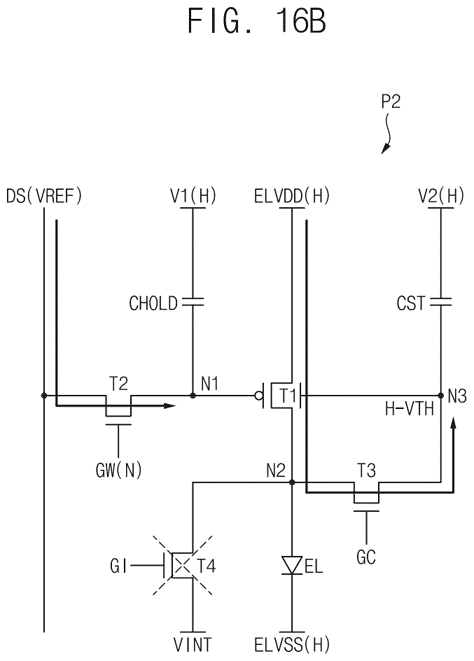

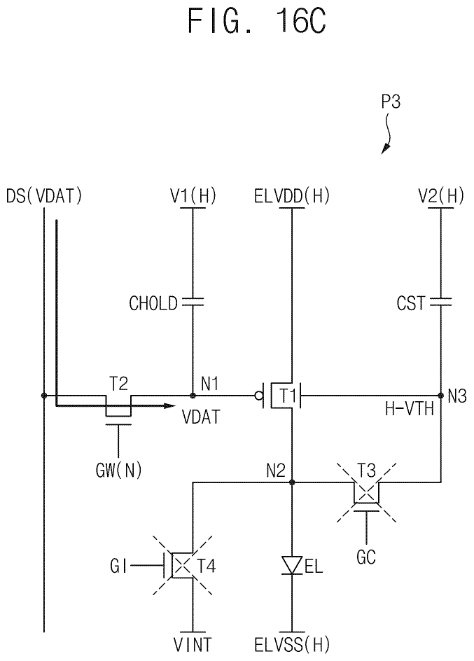

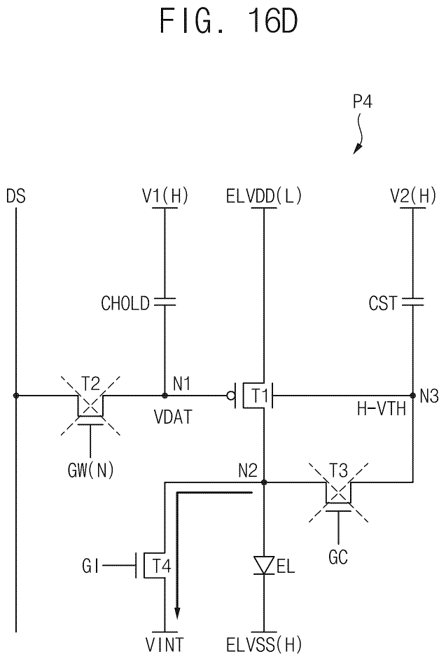

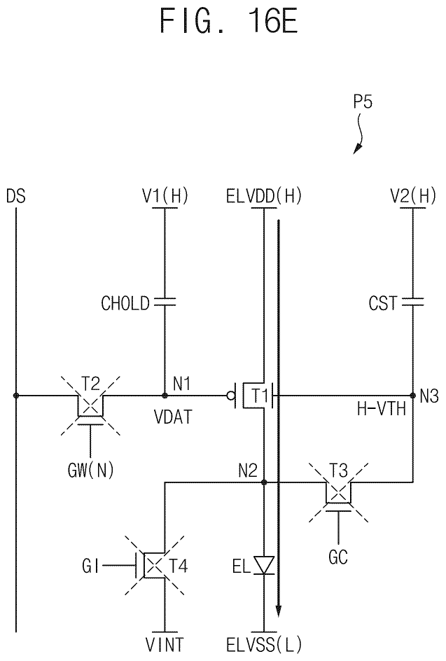

FIG. 15 is a timing diagram illustrating the voltages ELVDD, ELVSS, V1, and V2 and the signals GC, GW(N), and GI of FIG. 14. The voltages ELVDD, ELVSS, V1, and V2 and the signals GC, GW(N), and GI illustrated in FIG. 15 may be the same or substantially the same as (or similar to) the voltages ELVDD, ELVSS, V1, and V2 and the signals GC, GW(N), and GI described above with reference to FIG. 12. FIG. 16A through 16E are diagrams illustrating an operation of the pixel PX′ of FIG. 14.

Referring to FIGS. 15 and 16A, in the initialization period P1, the third transistor T3 may be turned on in response to the compensation gate signal GC having the activation level, the fourth transistor T4 may be turned on in response to the initialization gate signal GI having the activation level, and the initialization voltage VINT may be applied to the second node N2 and the third node N3 through the fourth 1 transistor T4 and the third transistor T3. Accordingly, in the initialization period P1, the second node N2 (e.g., the first terminal of the light-emitting element EL) and the third node N3 (e.g., the first terminal of the second capacitor CST) may be initialized by the initialization voltage VINT.

Referring to FIGS. 15 and 16B, in the compensation period P2, the second transistor T2 may be turned on in response to the write gate signal GW(N) having the activation level, and the reference voltage VREF may be applied to the first node N1 through the second transistor T2. Further, the third transistor T3 may be turned on in response to the compensation gate signal GC having the activation level, and a voltage H-VTH corresponding to a value obtained by subtracting a threshold voltage VTH of the first transistor T1 from the high level H of the first power voltage ELVDD may be applied to the third node N3 through the first transistor T1 and the third transistor T3. Accordingly, in the compensation period P2, the second capacitor CST may store the threshold voltage VTH of the first transistor T1.

Referring to FIGS. 15 and 16C, in the writing period P3, the second transistor T2 may be turned on in response to the write gate signal GW(N) having the activation level, and the data voltage VDAT may be applied to the first node N1 through the second transistor T2. Accordingly, the data voltage VDAT may be stored in the first node N1 in the writing period P3.

Referring to FIGS. 15 and 16D, in the bypass period P4, the fourth transistor T4 may be turned on in response to the initialization gate signal GI having the activation level, and the initialization voltage VINT may be applied to the second node N2 through the fourth transistor T4. Accordingly, in the bypass period P4, charges stored in the first terminal of the light-emitting element EL by a parasitic capacitance of the light-emitting element EL may be discharged to a line that transmits the initialization voltage VINT through the fourth transistor T4.

Referring to FIGS. 15 and 16E, in the emission period P5, the driving current generated by the first transistor T1 may flow through the light-emitting element EL. The light-emitting element EL may emit light having a luminance corresponding to the magnitude of the driving current. Because the second capacitor CST connected to the body of the first transistor T1 stores the threshold voltage VTH of the first transistor T1, a voltage of the body of the first transistor T1 may be fixed, and a threshold voltage deviation or variation between the first transistors T1 of the pixels PX may not occur. In other words, although the threshold voltages VTH of the first transistors T1 of the pixels PX may be different from each other, because voltages reflecting the threshold voltages VTH of the first transistors T1 are applied to the bodies of the first transistors T1, the threshold voltages VTH of the first transistors T1 of the pixels PX may become equal to or substantially equal to each other. Further, the magnitude of the driving current generated by the first transistor T1 may be controlled according to a gate-source voltage of the first transistor T1. Accordingly, in the emission period P5, the light-emitting element EL may emit light having a luminance corresponding to the data voltage VDAT, which is a voltage of the gate of the first transistor T1.

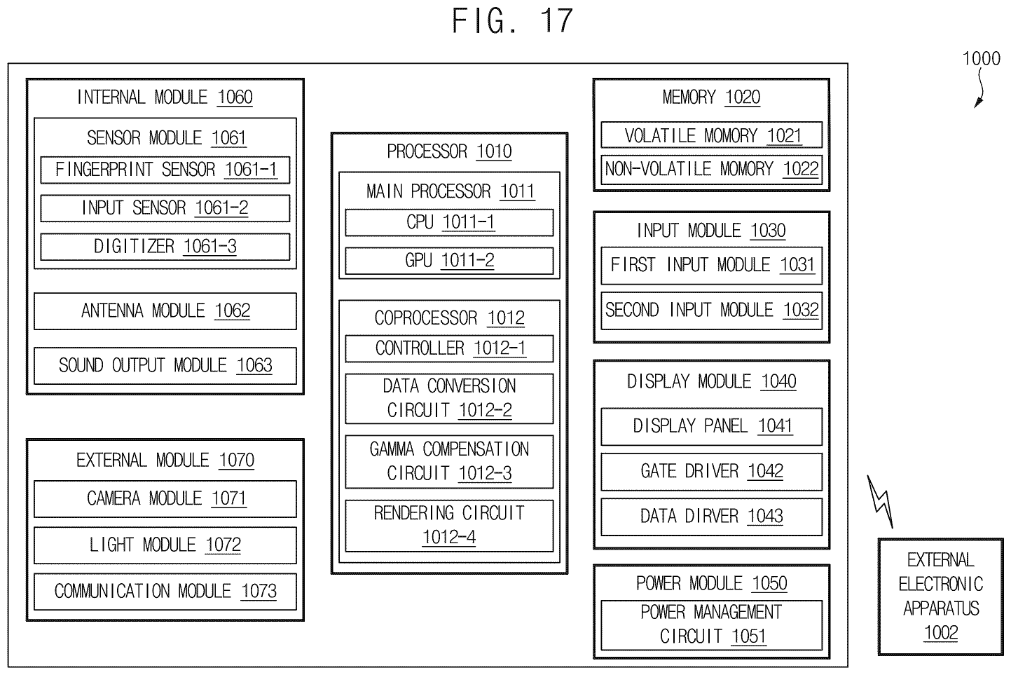

FIG. 17 is a block diagram illustrating an electronic apparatus 1000 according to an embodiment.

Referring to FIG. 17, the electronic apparatus 1000 may output various information through a display module 1040 within an operating system. When a processor 1010 executes an application stored in a memory 1020, the display module 1040 may provide application information to a user through a display panel 1041. In an embodiment, the processor 1010 may provide the input image data IMD1 and the control signal CTRL described above with reference to FIGS. 1 and 10 to the display module 1040.

The processor 1010 may obtain an external input through an input module 1030 or a sensor module 1061, and may execute an application corresponding to the external input. For example, when the user selects a camera icon displayed on the display panel 1041, the processor 1010 may obtain a user input through an input sensor 1061-2, and may activate a camera module 1071. The processor 1010 may transmit image data corresponding to a captured image acquired through the camera module 1071 to the display module 1040. The display module 1040 may display an image corresponding to the captured image through the display panel 1041. Some of the components of the electronic apparatus 1000 may be integrated with each other and provided as one component, or one component may be provided separately into two or more components.

The electronic apparatus 1000 may communicate with an external electronic apparatus 1002 through a network (e.g., a short-range wireless communication network or a long-range wireless communication network). In an embodiment, the electronic apparatus 1000 may include the processor 1010, the memory 1020, the input module 1030, the display module 1040, a power module 1050, an internal module 1060, and an external module 1070. In an embodiment, the electronic apparatus 1000 may not include at least one of the above-described components, or one or more other components may be added. In an embodiment, some of the above-described components (e.g., a sensor module 1061, an antenna module 1062, or a sound output module 1063) may be integrated into another component (e.g., the display module 1040).

The processor 1010 may execute software to control at least one other component (e.g., hardware or software component) of the electronic apparatus 1000 connected to the processor 1010, and may perform various data processing or calculation. In an embodiment, as at least part of a data processing or a calculation, the processor 1010 may store commands or data received from another component (e.g., the input module 1030, the sensor module 1061, or a communication module 1073) in a volatile memory 1021, may process the commands or data stored in the volatile memory 1021, and may store resultant data in a non-volatile memory 1022.

The processor 1010 may include a main processor 1011 and a coprocessor 1012. The main processor 1011 may include one or more of a central processing unit (CPU) 1011-1 or an application processor (AP). The main processor 1011 may further include one or more of a graphics processing unit (GPU) 1011-2, a communication processor (CP), or an image signal processor (ISP). At least two of the above-described processing units and processors may be implemented together as an integrated component (e.g., a single chip), or each may be implemented as an independent component (e.g., a plurality of chips).

The coprocessor 1012 may include a controller 1012-1. The controller 1012-1 may include an interface conversion circuit and a timing control circuit. The controller 1012-1 may receive an image signal from the main processor 1011, may convert data format of the image signal to suit interface specifications with the display module 1040, and may output image data. The controller 1012-1 may output various control signals used for driving the display module 1040.

The coprocessor 1012 may further include a data conversion circuit 1012-2, a gamma correction circuit 1012-3, a rendering circuit 1012-4, and the like. The data conversion circuit 1012-2 may receive the image data from the controller 1012-1, and may compensate for the image data so that the image is displayed at a desired luminance according to the characteristics of the electronic apparatus 1000 or the user's settings, or may convert the image data to reduce a power consumption or to compensate for afterimages. The gamma correction circuit 1012-3 may convert the image data or a gamma reference voltage, such that an image displayed on the electronic apparatus 1000 has desired gamma characteristics. The rendering circuit 1012-4 may receive the image data from the controller 1012-1, and may render the image data by considering a pixel arrangement of the display panel 1041 applied to the electronic apparatus 1000. At least one of the data conversion circuit 1012-2, the gamma correction circuit 1012-3, or the rendering circuit 1012-4 may be integrated into another component (e.g., the main processor 1011 or a controller). At least one of the data conversion circuit 1012-2, the gamma correction circuit 1012-3, or the rendering circuit 1012-4 may be integrated into a data driver 1043 described in more detail below.

The memory 1020 may store various data used by at least one component of the electronic apparatus 1000 (e.g., the processor 1010 or the sensor module 1061), and may input data or output data for commands related thereto. The memory 1020 may include at least one of the volatile memory 1021 or the non-volatile memory 1022.

The input module 1030 may receive commands or data to be used in the components of the electronic apparatus 1000 (e.g., the processor 1010, the sensor module 1061, or the sound output module 1063) from the outside of the electronic apparatus 1000 (e.g., the user or the external electronic apparatus 1002).

The input module 1030 may include a first input module 1031 through which commands or data are input from the user, and a second input module 1032 through which command or data are input from the external electronic apparatus 1002. The first input module 1031 may include a microphone, a mouse, a keyboard, a key (e.g., a button), or a pen (e.g., a passive pen or an active pen). The second input module 1032 may support a designated protocol that may connect to the external electronic apparatus 1002 by wire or wirelessly. In an embodiment, the second input module 1032 may include a high definition multimedia interface (HDMI), a universal serial bus (USB) interface, an SD card interface, or an audio interface. The second input module 1032 may include a connector that may be physically connected to the external electronic apparatus 1002, for example, such as an HDMI connector, a USB connector, an SD card connector, or an audio connector (e.g., a headphone connector).

The display module 1040 may provide visual information to the user. The display module 1040 may include the display panel 1041, a gate driver 1042, and the data driver 1043. The display module 1040 may further include a window, a chassis, and a bracket to protect the display panel 1041. The display module 1040 may correspond to the display device 100 described above with reference to FIG. 1 and/or the display device 101 described above with reference to FIG. 10. The display panel 1041 may correspond to the display panel described above, the gate driver 1042 may correspond to the gate driver 120 described above with reference to FIG. 1 and/or the gate driver 121 described above with reference to FIG. 10, and the data driver 1043 may correspond to the data driver 130 described above with reference to FIGS. 1 and/or 10.

The power module 1050 may supply power to the components of the electronic apparatus 1000. The power module 1050 may include a battery that charges a power voltage. The battery may include a non-rechargeable primary cell, a rechargeable secondary cell, or a fuel cell. The power module 1050 may include a power management circuit 1051. The power management circuit 1051 may supply optimized power to each of the above-described modules and the modules described below. The power management circuit 1051 may correspond to the power management circuit 140 described above with reference to FIG. 1 and/or the power management circuit 141 described above with reference to FIG. 10. The power module 1050 may include a wireless power transmission/reception member electrically connected to the battery. The wireless power transmission/reception member may include a plurality of coil-shaped antenna radiators.

The electronic apparatus 1000 may further include the internal module 1060 and the external module 1070. The internal module 1060 may include the sensor module 1061, the antenna module 1062, and the sound output module 1063. The external module 1070 may include the camera module 1071, a light module 1072, and a communication module 1073.

The sensor module 1061 may detect an input by the user's body or an input by the pen among the first input module 1031, and may generate an electrical signal or a data value corresponding to the input. The sensor module 1061 may include at least one of a fingerprint sensor 1061-1, an input sensor 1061-2, or a digitizer 1061-3.

The processor 1010 may output commands or data to the display module 1040, the sound output module 1063, the camera module 1071, or the light module 1072 based on the input data received from the input module 1030. For example, the processor 1010 may generate image data in response to input data applied through the mouse or the active pen, and may output the image data to the display module 1040, or may generate command data in response to the input data to output the command data to the camera module 1071 or the light module 1072. When no input data is received from the input module 1030 for a certain period of time, the processor 1010 may switch an operation mode of the electronic apparatus 1000 to a low-power mode or a sleep mode to reduce a power consumption of the electronic apparatus 1000.

The processor 1010 may output commands or data to the display module 1040, the sound output module 1063, the camera module 1071, or the light module 1072 based on sensing data received from the sensor module 1061. For example, the processor 1010 may compare authentication data authorized by the fingerprint sensor 1061-1 with authentication data stored in the memory 1020, and then may execute an application according to the comparison result. The processor 1010 may execute command or output corresponding image data to the display module 1040 based on sensing data detected by the input sensor 1061-2 or the digitizer 1061-3. When the sensor module 1061 includes a temperature sensor, the processor 1010 may receive temperature data for a temperature measured from the sensor module 1061, and may further perform a luminance correction for the image data or the like based on the temperature data.

The display device and the electronic apparatus according to some embodiments of the present disclosure may be applied to a display device included in (or may be implemented as) a computer, a notebook, a mobile phone, a smart phone, a smart pad, a smart watch, a PMP, a PDA, an MP3 player, or the like.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A pixel comprising:
a first transistor comprising a gate connected to a first node, a first terminal configured to receive a first power voltage, a second terminal connected to a second node, and a body connected to a third node;
a second transistor configured to transmit a data signal to the third node in response to a write gate signal;
a third transistor configured to connect the first node to the second node in response to a compensation gate signal;
a first capacitor connected between the third node and a first voltage line configured to transmit a first voltage;
a second capacitor connected between the first node and a second voltage line configured to transmit a second voltage; and
a light-emitting element comprising a first terminal connected to the second node, and a second terminal configured to receive a second power voltage.

2. The pixel of claim 1, wherein, in a third node initialization period of an initialization period, each of the first power voltage, the first voltage, and the second voltage has a high level, the write gate signal has an activation level, and the data signal has a sustain voltage.

3. The pixel of claim 2, wherein, in a second node initialization period of the initialization period after the third node initialization period, each of the first power voltage, the first voltage, and the second voltage has a low level.

4. The pixel of claim 3, wherein, in a first node initialization period of the initialization period after the second node initialization period, the second voltage transitions from the low level to the high level, and the compensation gate signal has an activation level.

5. The pixel of claim 2, wherein, in a compensation period after the initialization period, the write gate signal has the activation level, the compensation gate signal has an activation level, and the data signal has a reference voltage.

6. The pixel of claim 5, wherein, in a writing period after the compensation period, the write gate signal has the activation level, and the data signal has a data voltage.

7. The pixel of claim 6, wherein, in a bypass period after the writing period, each of the first power voltage, the first voltage, and the second voltage has a low level.

8. The pixel of claim 7, wherein, in an emission period after the bypass period, the first power voltage has the high level, and the second power voltage has a low level.

9. The pixel of claim 1, wherein the first transistor is a p-type metal oxide semiconductor (PMOS) transistor, and
wherein each of the second transistor and the third transistor is an n-type metal oxide semiconductor (NMOS) transistor.

10. The pixel of claim 1, wherein the first transistor is a PMOS transistor, and
wherein at least one of the second transistor or the third transistor is a PMOS transistor.

11. The pixel of claim 1, further comprising a fourth transistor configured to transmit an initialization voltage to the second node in response to an initialization gate signal.

12. A pixel comprising:
a first transistor comprising a gate connected to a first node, a first terminal configured to receive a first power voltage, a second terminal connected to a second node, and a body connected to a third node;
a second transistor configured to transmit a data signal to the first node in response to a write gate signal;
a third transistor configured to connect the second node to the third node in response to a compensation gate signal;
a first capacitor connected between the first node and a first voltage line configured to transmit a first voltage;
a second capacitor connected between the third node and a second voltage line configured to transmit a second voltage; and
a light-emitting element comprising a first terminal connected to the second node, and a second terminal configured to receive a second power voltage.

13. The pixel of claim 12, wherein, in an initialization period, each of the first power voltage and the first voltage has a low level, and the compensation gate signal has an activation level.

14. The pixel of claim 13, wherein, in a compensation period after the initialization period, the first power voltage has a high level, the write gate signal has an activation level, the compensation gate signal has the activation level, and the data signal has a reference voltage.

15. The pixel of claim 14, wherein, in a writing period after the compensation period, the write gate signal has the activation level, and the data signal has a data voltage.

16. The pixel of claim 15, wherein, in a bypass period after the writing period, each of the first power voltage and the first voltage has the low level.

17. The pixel of claim 16, wherein, in an emission period after the bypass period, the first power voltage has the high level, and the second power voltage has a low level.

18. The pixel of claim 12, further comprising a fourth transistor configured to transmit an initialization voltage to the second node in response to an initialization gate signal.

19. An electronic apparatus comprising:
a processor configured to generate input image data; and
a display device configured to display an image corresponding to the input image data, the display device comprising:
a display panel comprising pixels;
a gate driver configured to provide a write gate signal and a compensation gate signal to each of the pixels;
a data driver configured to provide a data signal to each of the pixels; and
a power management circuit configured to provide a first power voltage, a second power voltage, a first voltage, and a second voltage to each of the pixels,
wherein each of the pixels comprises:
a first transistor comprising a gate connected to a first node, a first terminal configured to receive the first power voltage, a second terminal connected to a second node, and a body connected to a third node;
a second transistor configured to transmit the data signal to the third node in response to the write gate signal;
a third transistor configured to connect the first node to the second node in response to the compensation gate signal;
a first capacitor connected between the third node and a first voltage line configured to transmit the first voltage;
a second capacitor connected between the first node and a second voltage line configured to transmit the second voltage; and
a light-emitting element comprising a first terminal connected to the second node, and a second terminal configured to receive the second power voltage.

20. The electronic apparatus of claim 19, wherein the gate driver is configured to:
sequentially provide the write gate signal to pixel rows; and
concurrently provide the compensation gate signal to the pixel rows.
